(19) United States
(12) Patent Application Publication
(10) Pub. No.: US 2023/0294657 A1
(43) Pub. Date: Sep. 21, 2023

(54) WHEEL HEAD MONITORING UNIT AND METHOD FOR DETECTING A MALFUNCTION OF A WHEEL HEAD

(71) Applicant: SAF-HOLLAND GmbH, Bessenbach (DE)

(72) Inventor: Bernd Brunsch, Dreieich (DE)

(21) Appl. No.: 18/006,034

(22) PCT Filed: Jun. 29, 2021
(86) PCT No.: PCT/EP2021/067801

§ 371 Date: Jan. 19, 2023

(30) Foreign Application Priority Data
Jul. 24, 2020 (DE) 10 2020 119 573.7

(51) Int. Cl. B60T 17/22; B60T 8/32; F16C 19/52

(52) U.S. Cl. CPC B60T 17/221; B60T 8/329; F16C 19/525; F16C 2326/02; F16C 2233/00

(57) ABSTRACT

A wheel head monitoring unit includes a first sensor unit, a second sensor unit and an evaluation unit, wherein the first sensor unit detects and/or is configured to detect at least a first measured value of a first wheel head, wherein the second sensor unit detects and/or is configured to detect a second measured value of a second wheel head, wherein the evaluation unit is configured to compare the first measured value with the second measured value and/or the first measured value with a predicted first measured value and/or time derivatives or integrations thereof, wherein the evaluation unit is configured in particular to output and/or store a signal if the difference of the first measured value from the second measured value and/or of the first measured value from the predicted first measured value exceeds a threshold value.

### BACKGROUND OF THE INVENTION

The invention relates to a wheel head monitoring unit and a method for detecting a malfunction of a wheel head, in each case in particular for commercial vehicles.

Wheel heads of axles and shafts are already known from the prior art and serve to support a wheel relative to a shaft and/or an axle and/or to brake a wheel relative to the axle or the shaft. However, the individual components of the wheel heads, such as the wheels, the wheel bearings or the brakes, among others, can exhibit malfunctions, in particular wear- related malfunctions, over time. These malfunctions should be detected as early as possible to avoid possible consequential damage. It is known, for example, that a wear sensor can be used to detect when brake pads have reached their wear limit. However, this type of early detection requires the exact recording of a predefined variable and a comparison with precisely known threshold values, so that an exact recording of the measured variable is necessary to detect a malfunction of the wheel head.

It is therefore the object of the present invention to achieve a particularly robust way of determining malfunctions in wheel heads, even without the need for precisely known threshold values.

### SUMMARY OF THE INVENTION

According to the invention, a wheel head monitoring unit comprises a first sensor unit, a second sensor unit and an evaluation unit, the first sensor unit detecting and/or being designed to detect at least a first measured value of a first wheel head, the second sensor unit detecting and/or being designed to detect a second measured value of a second wheel head, the evaluation unit being designed to compare the first measured value with the second measured value and/or the first measured value with a predicted first measured value and/or their time derivatives and/or their integrations over time, the evaluation unit being designed in particular to output and/or store a signal if the difference between the first measured value and the second measured value and/or between the first measured value and the predicted first measured value exceeds a threshold value. In other words, the wheel head monitoring unit according to the invention is used to monitor and/or detect malfunction of components of a wheel head. In this context, the wheel head monitoring unit is in particular a commercial vehicle wheel head monitoring unit. The wheel head monitoring unit thus suitably monitors the wheel heads of a commercial vehicle. The invention may therefore also relate to a commercial vehicle having a wheel head monitoring unit. In this context, a commercial vehicle within the meaning of the invention is in particular a towing vehicle, preferably roadworthy and/or road-bound, or a trailer with a permissible total mass of more than 3.5 tons, preferably more than 7.5 tons and particularly preferably more than 15 tons. In this context, the wheel heads according to the invention form, in particular, the radially outward-facing components of an axle unit or a shaft unit and serve, in particular, to support and/or brake a wheel of the wheel head. In other words, the wheel heads according to the invention therefore comprise in particular, inter alia, the braking system, the wheel hubs, the wheels to be supported and/or the bearing units of an axle or a shaft. An axle or shaft of this type usually has a first and a second wheel head at the opposite ends in each case. Thus, each axle of a vehicle usually has a left and a right wheel head. The wheel head monitoring unit according to the invention has a first sensor unit and a second sensor unit. Here, the first sensor unit is adapted to detect a first measured value of a first wheel head and the second sensor unit is adapted to detect a second measured value of a second wheel head. In other words, this can mean that, for example, the first sensor unit is designed to detect a measured value of a left wheel head of an axle and the second sensor unit is designed to detect a measured value of a right wheel head of this axle. Advantageously, the first measured value and the second measured value are identical to each other. By identical it is to be understood in particular that the first measured value and the second measured value represent in each case the same physical quantity of the same unit or the same component of the respective wheel head in each case at the first wheel head or at the second wheel head. Therefore, for example, the first sensor unit may be designed to detect a braking temperature of the first wheel head and the second sensor unit may be designed to detect a braking temperature of the second wheel head. By this acquisition of identical measured values, which are acquired by the first sensor unit and the second sensor unit, a comparability of the two measured values can be achieved. The first sensor unit and the second sensor unit can thereby have several different sensors, which are each designed to detect different physical variables and/or properties of the first wheel head and/or the second wheel head, in particular also of different elements and/or components of the respective wheel head. A sensor unit can consist of several different sensors. These sensors may thereby be arranged at different locations and/or elements of the wheel head and/or all or partially contained in a housing. The first sensor unit and/or the second sensor unit may comprise an integral sensor, which is designed to detect multiple physical quantities. Advantageously, the wheel head monitoring unit is thereby designed in such a way that each wheel head of the commercial vehicle has its own sensor unit. This can mean that the wheel head monitoring unit has not only a first sensor unit and a second sensor unit, but a plurality of sensor units, each of which is assigned to a corresponding wheel head and/or is arranged in the area of the respective wheel head. In this context, “assigned” means that the respective sensor unit is designed to detect and/or determine physical measured variables of the respective assigned wheel head. In addition to the sensor units, the wheel head monitoring unit according to the invention also has an evaluation unit. This evaluation unit is designed and/or configured to compare the first measured value with the second measured value and/or to compare the first measured value with a predicted measured value. This comparison of the measured values or of the measured value with a predicted measured value can not only detect the measured value itself, but can also be designed in such a way that not the measured values but the time derivatives of the measured values are compared. This can mean that the evaluation unit can serve not only to compare measured values themselves, but alternatively or additionally preferably the evaluation unit can also be designed in such a way that time derivatives and/or time integrations of the measured values can be determined by the evaluation unit. As already explained, the evaluation unit can not only compare individual measured values with each other, but alternatively and/or additionally preferably the evaluation unit can also be designed in such a way that the first measured value and/or the second measured value can be compared with a predicted corresponding measured value. In other words, the evaluation unit can therefore not only compare already recorded measured values with each other but also determine that a certain predicted measured value is not reached and/or exceeded. Such a predicted first measured value and/or second measured value can be obtained, for example, by the fact that a certain braking temperature should occur due to the applied braking pressure and/or the existing speed of the vehicle and/or the rotational speed of the wheel of the wheel head. This predicted braking temperature can thereby be predicted, for example, via previously recorded measured values and empirical values, in particular by the use of neural networks. If the expected or predicted measured value, for example the braking temperature, does not match the first recorded actual measured value, a malfunction of the wheel head can be detected or determined via the wheel head monitoring unit. In this context, the evaluation unit is designed in particular such that it outputs and/or stores a signal if the difference between the first measured value and the second measured value and/or if the difference between the first measured value and the predicted (first) measured value exceeds a threshold value. In other words, the evaluation unit can be such that it stores and/or outputs a warning or a warning signal if the difference between the first and the second measured value and/or between the first measured value and the expected or predicted measured value exceeds and/or falls below a certain magnitude. For example, this difference may be 10 percent, 20 percent or 30 percent of the expected or the detected first measured value. In other words, the wheel head monitoring unit or its evaluation unit is designed in such a way that a warning is output and/or stored only when a difference exceeding the measurement tolerance is exceeded. By means of the monitoring unit according to the invention, it is possible in a simple manner to easily and reliably detect a malfunction of a wheel head and/or elements of the wheel head without having to resort to, in particular, static and/or previously known threshold values. Therefore, the wheel head monitoring unit according to the invention is significantly less susceptible to dynamically changing conditions, such as environmental influences and/or ambient temperatures.

It is expedient that the first sensor unit and/or the second sensor unit is/are designed to detect a variety of measured variables. In other words, the wheel head monitoring unit or the first sensor unit and/or the second sensor unit can be designed to detect different types of measured variables. These measured variables can be the temperature, in particular of a brake of the respective wheel head, the applied brake pressure, the rotational speed of the wheel of the respective wheel head, the existing support load of the wheel and/or the existing vibration frequency and/or amplitude of the wheel head. Advantageously, the first and second sensor units are designed in such a way that they record identical measured values at the first and second wheel head, respectively. In other words, this can mean that the first and second sensor units each record identical values or measured variables at different wheel heads. By determining a plurality of measured variables at the first wheel head and/or at the second wheel head by the first or second sensor unit, the spectrum of components to be monitored or the accuracy of the determination of a malfunction of the first or second wheel head can be increased.

Preferably, the first sensor unit and/or the second sensor unit are designed to detect a temperature, in particular of a brake, a brake disc and/or brake linings of the first and/or the second wheel head. In other words, the first sensor unit and/or the second sensor unit may therefore comprise at least one temperature sensor. In this regard, the determination of a temperature may indicate a malfunction in a variety of ways. In particular, a failure to increase the temperature during braking may indicate that the brake itself cannot provide the required dissipation power. Therefore, by monitoring the temperature, in particular of a brake, or the components of the brakes, a malfunction of the braking system can be detected in a reliable manner. Thus, such an embodiment of the wheel head monitoring unit can significantly increase the operating unit of a vehicle, in particular a commercial vehicle.

The first sensor unit and/or the second sensor unit are expediently designed to detect a temperature of a bearing, in particular a wheel bearing, of the first and/or the second wheel head. By determining the temperature of a bearing, in particular a wheel bearing, of the first and/or second wheel head, a malfunction or damage to the bearing can be reliably detected. In this way, in particular imminent failures of the vehicle can be detected at an early stage by the wheel head monitoring unit. Advantageously, at least one monitored bearing is a wheel bearing of the respective wheel head.

Advantageously, the first sensor unit and/or the second sensor unit is/are designed to detect at least one operating state characteristic value of an auxiliary drive of the first and/or the second wheel head. In other words, the first and/or the second wheel head can therefore have an auxiliary drive, in particular a hydraulic or an electric auxiliary drive. An operating state characteristic value is in particular a value characterizing an operating state of the respective auxiliary drive. For example, in the case of a hydraulic auxiliary drive, an operating state characteristic value may be a pressure and/or a flow volume from or to the auxiliary drive. For example, for an electric auxiliary drive, an operating condition characteristic value may be a voltage dropped across the drive and/or current flowing through the drive. By monitoring the auxiliary drive, a malfunction of the drive can be reliably detected in a simple manner.

Preferably, the first sensor unit and/or the second sensor unit is/are designed to detect a rotational speed of the wheel, in particular a wheel of a lift axle, of the first and/or the second wheel head. By detecting the rotational speed, for example, a burst tire of a wheel head can be detected and/or determined in an effective manner. If the wheel whose rotational speed is detected is a wheel on a lift axle, the wheel head monitoring unit can serve to use the run-out behaviour of this wheel in the event of a bottomless contact to determine a malfunction, in particular of a wheel bearing, of the respective wheel head. In addition, by determining the speed, especially in the case of lift axles, conclusions can be drawn not only about the bearing but also, for example, about seizing brake calipers, which can be easily detected by a wheel head monitoring unit designed in this way.

Advantageously, the wheel head monitoring unit comprises a plurality of sensor units, in particular four, six or eight, each sensor unit detecting and/or being designed to detect at least one measured value of a respective wheel head. In other words, the wheel head monitoring unit can monitor not only two wheel heads, but rather it is advantageous to equip each wheel head of a commercial vehicle with its own sensor unit in each case. Advantageously, the sensor units of the wheel heads are designed to be identical to each other. In other words, this can mean that the sensor units of the respective wheel heads are designed in such a way that they detect the same physical variables at each wheel head. By using a plurality of sensor units on different wheel heads in each case, the reliability of the system can be significantly increased. In addition, this multiplicity of measured values can also be used to determine the location of the malfunction, because, for example, if only two wheel heads are used, it is possible to detect a malfunction, but it is not possible to clearly detect which of the two measuring points has a malfunction in a simple manner. However, if a large number of measuring points or wheel heads are monitored, it is much easier to determine which of the wheel heads or which of the elements of the wheel heads has a malfunction. Advantageously, the evaluation unit is designed in such a way that it not only compares individual measured values and/or measured values with the corresponding predicted measured values, but can also compare average values of all measured values with individual measured values in each case. This can reduce the triggering of misidentifications of malfunctions.

Expediently, the wheel head monitoring unit comprises an ambient temperature sensor. The presence of an ambient temperature sensor makes it particularly easy to identify an existing malfunction of a sensor unit, so that the accuracy of the detection of a malfunction can be increased and/or self-monitoring of the wheel head monitoring unit can be implemented by the ambient temperature sensor. Alternatively, or additionally preferably, the ambient temperature sensor can also be used to calibrate individual temperature sensors of the sensor units of the wheel head monitoring unit. In other words, this may mean that the ambient temperature sensor can be used, among other things, to eliminate drift of a sensor. For example, this can be achieved by adjusting the calibration curve of each of the temperature sensors of the wheel head monitoring unit to the ambient temperature sensor after a longer standstill. This can achieve significantly more accurate monitoring by the wheel head monitoring unit and/or reduce the triggering of false identifications of defective components.

Expediently, the first sensor unit and/or the second sensor unit comprises a vibration sensor. By providing a vibration sensor, a malfunction of individual components can be identified in a variety of ways. For example, this can be done by making a comparison with respect to both a difference in a frequency and/or a difference in an amplitude. For example, this can be used to detect bearing damage due to an increase in vibration. The vibration sensor is advantageously designed in such a way that it detects the vibrations in at least two spatial directions perpendicular to one another, so that in particular a large number of different modes of the respective wheel heads and/or its components can be detected. A further advantage of a vibration sensor is that vibrations can be recorded at a wide variety of locations on the wheel head, wherein the cause of this vibration can originate at significantly different locations.

Advantageously, the wheel head monitoring unit is a commercial vehicle wheel head monitoring unit. In other words, this may mean that the wheel head monitoring unit is mounted on a commercial vehicle and/or is designed to be mounted on a commercial vehicle. It is particularly preferred if the wheel head monitoring unit is a trailer wheel head monitoring unit, in particular a semi-trailer wheel head monitoring unit. This applies in particular due to the fact that a malfunction of components of a wheel head of a trailer, in particular a semitrailer, often remains undetected and can lead to serious accidents. The wheel head monitoring unit according to the invention can therefore be used, in particular by mounting it on a commercial vehicle, advantageously a semi-trailer, to increase the operational safety of commercial vehicles, advantageously semi-trailers. In other words, therefore, the invention may in particular also relate to a trailer, in particular a semi-trailer, having a wheel head monitoring unit as described above and described below.

Another aspect of the invention relates to a method for detecting a malfunction of a wheel head, in particular using a wheel head monitoring unit as described above and below, comprising the steps of: detecting a first measured value of a first wheel head; detecting a second measured value of a second wheel head; comparing the first measured value with the second measured value. Alternatively, or additionally preferably, the first measured value may be compared to a predicted measured value. By means of the method according to the invention, a malfunction of individual components or of individual elements of a wheel head can be identified in a simple manner. The method according to the invention can thereby be further formed in a corresponding manner as described above and below and/or have the features described above and below with respect to the wheel head monitoring unit.

### BRIEF DESCRIPTION OF THE DRAWINGS

Further advantages and features of the present invention will be apparent from the following description with reference to the figures. Individual features of the embodiments shown can thereby also be used in other embodiments, unless this has been expressly excluded. Showing:

FIG. 1 is a wheel head monitoring unit;

FIG. 2 is a comparison of a first measured value with a second measured value; and

FIG. 3 is another wheel head monitoring unit.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

FIG. 1 shows a wheel head monitoring unit 1. This wheel head monitoring unit 1 is used to monitor a first wheel head 2 and a second wheel head 4 of a rigid axle of a commercial vehicle. The wheel head monitoring unit 1 has a first sensor unit 10 and a second sensor unit 30, wherein the first sensor unit 10 is arranged in a brake system of the first wheel head 2. The second sensor unit 30, on the other hand, is arranged in a brake system of the second wheel head 4. The first sensor unit 10 and the second sensor unit 30 are connected to the evaluation unit 50 in terms of information technology, in particular by a wired connection or preferably by a wireless connection. The evaluation unit 50 serves to compare the first measured value Ml, which is detected by the first sensor unit 10, with the second measured value M2, which is detected by the second sensor unit 30. It may be preferred if the evaluation unit 50 is included in the first sensor unit 10 and/or the second sensor unit 30. Alternatively, preferably, the evaluation unit 50 can also be part of an already existing system, in particular for example an ABS system. In this case, the evaluation unit 50 can not only compare the first measured value M1 with the second measured value M2, but can additionally or alternatively, for example, compare the first measured value M1 with a predicted first measured value. This comparison may thereby refer to the measured values themselves and/or to the temporal derivatives of the measured values and/or the temporal integration of the measured value over time. In other words, the time derivatives of the measured values or the integral value of the measured values can also be compared.

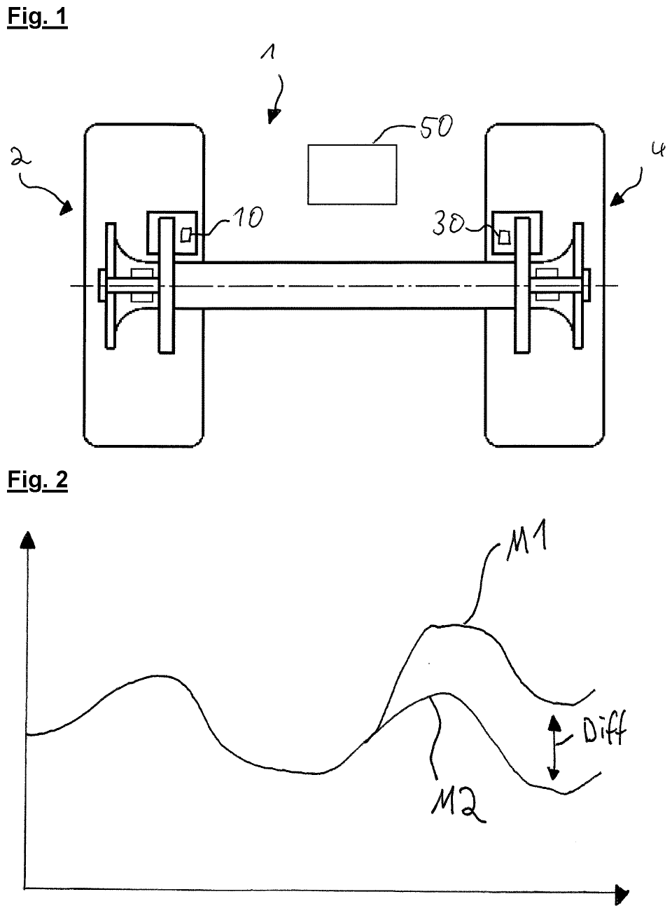

FIG. 2 shows a time history of a first measured value M1 with a second measured value M2. As can be seen in FIG. 2, the first measured value M1 and the second measured value M2 have a difference Diff from a certain point in time to each other, wherein this difference Diff of the measured values M1, M2 indicates a conclusion about a malfunction of an element or a component of the first wheel head 2 or the second wheel head 4.

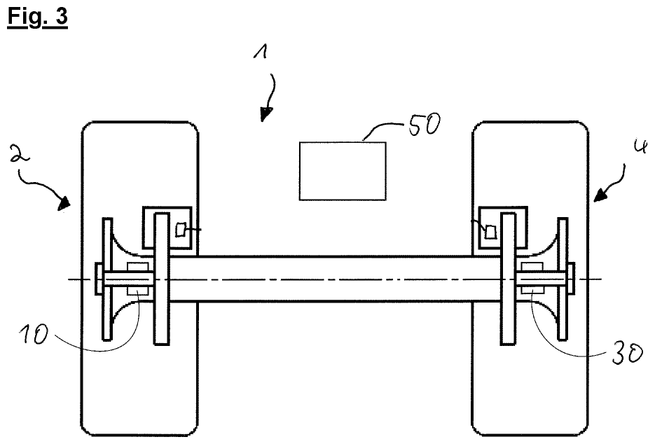

FIG. 3 shows a further embodiment of a wheel head monitoring unit 1. In principle, the embodiment shown in FIG. 3 can be combined with the variant shown in FIG. 1. The wheel head monitoring unit 1 is used to monitor a first wheel head 2 and a second wheel head 4 of a rigid axle of a commercial vehicle, in particular a commercial vehicle trailer. The wheel head monitoring unit 1 has a first sensor unit 10 and a second sensor unit 30, wherein the first sensor unit 10 is arranged in a wheel bearing unit of the first wheel head 2. The second sensor unit 30, on the other hand, is arranged in a wheel bearing unit of the second wheel head 4.

### LIST OF REFERENCE SIGNS

1—wheel head monitoring unit
2—first wheel head
4—second wheel head
10—first sensor unit
30—second sensor unit
50—evaluation unit
Diff—difference of the first measured value to the second measured value
M1—first measured value
M2—second measured value

1-12. (canceled)

13. A wheel head monitoring unit, comprising:
a first sensor unit;
a second sensor unit; and
an evaluation unit;
wherein the first sensor unit is configured to detect at least a first measurement value of a first wheel head;
wherein the second sensor unit is configured to detect a second measurement value of a second wheel head;
wherein the evaluation unit is configured to compare the first measured value with the second measured value, and/or
the evaluation unit is configured to compare time derivatives or integrations of the first measured value with the second measured value; and
wherein the evaluation unit is configured to output and/or store a signal if the difference of the first measured value to the second measured value exceeds a threshold value; and
wherein the wheel head monitoring unit comprises an ambient temperature sensor.

14. The wheel head monitoring unit according to claim 13, wherein the first sensor unit and/or the second sensor unit is/are configured to detect a plurality of measured variables.

15. The wheel head monitoring unit according to claim 14, wherein the first sensor unit and/or the second sensor unit is/are configured to detect a temperature of a component of the first and/or of the second wheel head of a brake of a brake disc and/or of brake linings of the first or of the second wheel head.

16. The wheel head monitoring unit according to claim 15, wherein the first sensor unit and/or the second sensor unit is/are configured to detect a temperature of a wheel bearing of the first and/or the second wheel head.

17. The wheel head monitoring unit according to claim 16, wherein the first sensor unit and/or the second sensor unit is/are configured to detect a rotational speed of a wheel of a lift axle of the first and/or the second wheel head.

18. The wheel head monitoring unit according to claim 17, further comprising:
a plurality of sensor units, where each sensor unit is configured to detect at least one measured value of a respective wheel head.

19. The wheel head monitoring unit according to claim 18, where the plurality of sensor units includes at least four sensor units.

20. The wheel head monitoring unit according to claim 18, wherein the first sensor unit and/or the second sensor unit comprises/comprise a vibration sensor.

21. The wheel head monitoring unit according to claim 20, wherein the wheel head monitoring unit includes a commercial vehicle wheel head monitoring unit.

22. The wheel head monitoring unit according to claim 13, wherein the first sensor unit and/or the second sensor unit is/are configured to detect a temperature of a component of the first and/or of the second wheel head of a brake of a brake disc and/or of brake linings of the first or of the second wheel head.

23. The wheel head monitoring unit according to claim 13, wherein the first sensor unit and/or the second sensor unit is/are configured to detect a temperature of a wheel bearing of the first and/or the second wheel head.

24. The wheel head monitoring unit according to claim 13, wherein the first sensor unit and/or the second sensor unit is/are configured to detect a rotational speed of a wheel of a lift axle of the first and/or the second wheel head.

25. The wheel head monitoring unit according to claim 13, further comprising:
a plurality of sensor units, where each sensor unit is configured to detect at least one measured value of a respective wheel head.

26. The wheel head monitoring unit according to claim 25, where the plurality of sensor units includes at least four sensor units.

27. The wheel head monitoring unit according to claim 13, wherein the first sensor unit and/or the second sensor unit comprises/comprise a vibration sensor.

28. The wheel head monitoring unit according to claim 13, wherein the wheel head monitoring unit includes a commercial vehicle wheel head monitoring unit.

30. A method for detecting a malfunction of a wheel head using a wheel head monitoring unit according to claim 13, comprising:
detection of the first measured value of the first wheel head;
detection of the second measured value of the second wheel head; and
comparing the first measured value with the second measured value.

31. A commercial vehicle comprising the wheel head monitoring unit according to claim 13.

32. A commercial vehicle according to claim 31, wherein the commercial vehicle includes a commercial vehicle trailer.
